(19) United States
(12) Patent Application Publication
(10) Pub. No.: US 2008/0080673 A1
(43) Pub. Date: Apr. 3, 2008

(54) RADIATION IMAGE CAPTURING APPARATUS AND GRID MOVING DEVICE

(75) Inventor: Hiroshi YAMAKITA, Minamiashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/865,098

(22) Filed: Oct. 1, 2007

(30) Foreign Application Priority Data
Sep. 29, 2006 (JP) 2006-268237

(51) Int. Cl. G21K 1/02

(52) U.S. Cl. 378/155

(57) ABSTRACT

A radiation image capturing apparatus includes a radiation source for applying radiation to a subject, a radiation image information detector for detecting radiation from the radiation source that has passed through the subject in order to capture radiation image information of the subject, a grid disposed between the subject and the radiation image information detector for removing scattered radiation rays produced when the radiation passes through the subject, a grid moving mechanism for moving the grid in at least one direction, and a grid movement controller for controlling the grid moving mechanism. The grid moving mechanism moves the grid such that vt=constant, where v represents a speed at which the grid is moved and t represents a period elapsed from a time when the grid starts to move.

### BACKGROUND OF THE INVENTION

1. Field of the Invention

The present invention relates to a radiation image capturing apparatus, including a grid disposed between a subject to be imaged and a radiation image information detector for removing scattered radiation rays that are generated when radiation passes through the subject, together with a grid moving device for moving the grid.

2. Description of the Related Art

In the medical field, radiation image capturing apparatuses have widely been used, which apply radiation emitted from a radiation source toward a subject, and which guide the radiation that has passed through the subject to a solid-state detector or a stimulable phosphor panel in order to record radiation image information of the subject.

The solid-state detector includes a solid-state detecting unit comprising a laminated assembly made up of a matrix of charge collecting electrodes formed on an insulating substrate, and a radiation conductor disposed on the charge collecting electrodes for generating electric charges depending on the radiation that is applied to the solid-state detecting unit. The electric charges generated by the radiation conductor and representing radiation image information are collected by the charge collecting electrodes and temporarily stored in an electric storage unit. The collected electric charges are converted into electrical signals, which are output from the solid-state detector.

The stimulable phosphor panel is a panel coated with a stimulable phosphor which, when exposed to an applied radiation, stores part of the energy of the radiation, and, when subsequently exposed to applied stimulating light such as a laser beam or the like, emits stimulated light in proportion to the stored radiation energy. The radiation image information can be read from the stimulable phosphor panel by photoelectrically converting the stimulated light emitted from the stimulable phosphor panel.

One such radiation image capturing apparatus is known as a mammographic apparatus for use in breast cancer screening. The mammographic apparatus comprises an image capturing base for supporting a subject's breast, the image capturing base incorporating a panel-shaped solid-state detector, a breast compression plate disposed opposite to the image capturing base for pressing the breast against the image capturing base, and a radiation source for applying radiation through the breast compression plate to the breast (see, for example, Japanese Patent No. 2500895).

Generally, when radiation that has passed through a subject is detected and radiation image information of the subject is acquired from the detected radiation, the acquired radiation image information contains not only a component representative of the radiation rays that passed straight through the subject, but also a component representative of scattered radiation rays, which were generated when the radiation passed through the subject. Consequently, an image generated from the acquired radiation image information tends to be blurred.

Heretofore, it has been proposed to place a grid between the subject and a radiation image information detector, for removing scattered radiation rays that are generated when radiation passes through the subject. Since the grid tends to produce grid stripes (grid irregularities) in the image generated from the acquired radiation image information, a grid moving mechanism also is employed to move the grid in one direction. For details, reference should be made to Japanese Laid-Open Patent Publication No. 2000-116648 and Japanese Laid-Open Patent Publication No. 10-305030, for example.

According to the grid moving mechanism disclosed in Japanese Laid-Open Patent Publication No. 2000-116648, the speed at which the grid is moved is commensurate with variations in the radiation intensity, and the distance that the grid is moved is close to an integral multiple of the grid pitch. According to the grid moving mechanism disclosed in Japanese Laid-Open Patent Publication No. 10-305030, the distance that the grid is moved, which changes with time, is represented by a continuous curve, which is symmetrical about a position that corresponds to one-half of the exposure time.

Japanese Patent No. 2500895 discloses a grid moving mechanism for controlling movement of a grid after information is acquired from an AEC (Automatic Exposure Control) sensor. The disclosed grid moving mechanism requires that a complex control process be performed, which is liable to be affected by the AEC sensor. Another problem is that if the exposure time is long, limitations are posed on efforts to increase the accuracy of the grid movement control.

The grid moving mechanism disclosed in Japanese Laid-Open Patent Publication No. 2000-116648 moves the grid at a high speed near a movement start position and a movement end position, i.e., a position at an exposure end time. Depending on image capturing conditions, non-negligible grid irregularities may occur and remain at the time the grid stops. The grid moving mechanism also is problematic in that the grid moving mechanism is subject to large loads, because the grid moves back at a high speed when it reaches the stroke end point.

### SUMMARY OF THE INVENTION

It is an object of the present invention to provide a radiation image capturing apparatus, which is capable of reducing grid irregularities to a certain level or below regardless of the length of exposure time, and of reducing loads applied when the grid moves backward when it reaches a stroke end point, as well as to provide a grid moving device for moving such a grid.

According to a first aspect of the present invention, there is provided a radiation image capturing apparatus comprising a radiation source for applying radiation to a subject, a radiation image information detector for detecting radiation from the radiation source that has passed through the subject in order to capture radiation image information of the subject, a grid disposed between the subject and the radiation image information detector for removing scattered radiation rays produced when the radiation passes through the subject, and a grid moving mechanism for moving the grid in at least one direction, wherein the grid moving mechanism moves the grid so that

vt=constant

where v represents a speed at which the grid is moved, and t represents a period elapsed from a time when the grid starts to move.

In the radiation image capturing apparatus according to the first aspect, the grid moving mechanism moves the grid a distance X to be traveled by the grid, according to the following equation (1):

X=a·log(t+b) (1)

where a and b represent coefficients inherent to the radiation image capturing apparatus.

In the radiation image capturing apparatus according to the first aspect, the grid moving mechanism determines the coefficient b of equation (1) based on a minimum exposure period, during which a minimum radiation dose of required radiation is supplied to the radiation image information detector.

In the radiation image capturing apparatus according to the first aspect, the grid moving mechanism determines the coefficient a of equation (1) based on a maximum exposure period, during which a maximum radiation dose of required radiation is supplied to the radiation image information detector, together with a maximum displacement of the grid.

In the radiation image capturing apparatus according to the first aspect, the grid moving mechanism determines the coefficient b of equation (1) based on a minimum exposure period, during which a minimum radiation dose of required radiation is supplied to the radiation image information detector, and thereafter determines the coefficient a of equation (1) based on a maximum exposure period, during which a maximum radiation dose of required radiation is supplied to the radiation image information detector together with a maximum displacement of the grid.

In the radiation image capturing apparatus according to the first aspect, the grid moving mechanism comprises a rotational shaft, which is rotatable in a period that is longer than a maximum exposure period, during which a maximum radiation dose of required radiation is supplied to the radiation image information detector, and a cam mounted on the rotational shaft and including a grid pressing surface whose distance from the rotational shaft varies continuously, wherein the grid moving mechanism moves the grid according to equation (1) by rotating the rotational shaft.

In the radiation image capturing apparatus according to the first aspect, the grid moving mechanism further comprises an urging means for urging the grid to move toward the rotational shaft.

In the radiation image capturing apparatus according to the first aspect, the grid moving mechanism comprises a moving means for moving the grid in at least one direction, and a limiting means for limiting movement of the grid by the moving means, wherein the grid moving mechanism moves the grid according to equation (1) by moving the grid with the moving means, together with limiting movement of the grid by the limiting means.

The limiting means may comprise a spring or a damper.

In the radiation image capturing apparatus according to the first aspect, the grid moving mechanism comprises a motor, a rotation-to-linear-movement converting mechanism for converting rotary motion of the motor into linear motion of the grid, and a control means for controlling the motor, wherein the control means controls the motor to move the grid according to equation (1).

According to a second aspect of the present invention, there is further provided a radiation image capturing apparatus comprising a radiation source for applying radiation to a subject, a radiation image information detector for detecting radiation from the radiation source that has passed through the subject in order to capture radiation image information of the subject, a grid disposed between the subject and the radiation image information detector for removing scattered radiation rays produced when radiation passes through the subject, and a grid moving mechanism for moving the grid in at least one direction, wherein the grid moving mechanism moves the grid so that

E(t)/vt=constant

where v represents a speed at which the grid is moved, t represents a period elapsed from a time when the grid starts to move, and E(t) represents a time-dependent change in the radiation dose.

According to a third aspect of the present invention, there is further provided a grid moving device in a radiation image capturing apparatus including a radiation source for applying radiation to a subject, and a radiation image information detector for detecting radiation from the radiation source that has passed through the subject in order to capture radiation image information of the subject, wherein the grid moving device comprises a grid disposed between the subject and the radiation image information detector for removing scattered radiation rays produced when radiation passes through the subject, and a grid moving mechanism for moving the grid in at least one direction, wherein the grid moving mechanism moves the grid so that

vt=constant

where v represents a speed at which the grid is moved and t represents a period elapsed from a time when the grid starts to move.

According to a fourth aspect of the present invention, there is further provided a grid moving device in a radiation image capturing apparatus including a radiation source for applying radiation to a subject, and a radiation image information detector for detecting radiation from the radiation source that has passed through the subject in order to capture radiation image information of the subject, wherein the grid moving device comprises a grid disposed between the subject and the radiation image information detector for removing scattered radiation rays produced when radiation passes through the subject, and a grid moving mechanism for moving the grid in at least one direction, wherein the grid moving mechanism moves the grid so that

E(t)/vt=constant

where v represents a speed at which the grid is moved, t represents a period elapsed from a time when the grid starts to move, and E(t) represents a time-dependent change in the radiation dose.

With the radiation image capturing apparatus as well as the grid moving device according to the present invention, generation of grid irregularities is kept at a certain level or lower, regardless of the length of an effective exposure period.

The above and other objects, features, and advantages of the present invention will become more apparent from the following description when taken in conjunction with accompanying drawings, in which a preferred embodiment of the present invention is shown by way of illustrative example.

### BRIEF DESCRIPTION OF THE DRAWINGS

FIG. 1 is a perspective view of a radiation image capturing apparatus according to an embodiment of the present invention;

FIG. 2 is a fragmentary vertical elevational view, partly in cross section, showing internal structural details of an image capturing base of the radiation image capturing apparatus according to the embodiment of the present invention;

FIG. 3 is a perspective view of an AEC sensor moving mechanism of the radiation image capturing apparatus according to the embodiment of the present invention;

FIG. 4 is a block diagram of a control circuit of the radiation image capturing apparatus according to the embodiment of the present invention;

FIG. 5 is a diagram showing a waveform of an original grid irregularity;

FIG. 6 is a diagram showing a waveform of an MTF-dependent grid irregularity;

FIG. 7 is a diagram showing a distance X that a grid is moved as it changes with time t;

FIG. 8 is a diagram showing A grid irregularity whose level varies with exposure time;

FIG. 9 is a perspective view, partly in block form, of a first grid moving mechanism, which is controlled by a first grid movement controller;

FIG. 10 is an elevational view showing a profile of a cam of the first grid moving mechanism;

FIG. 11 is a perspective view, partly in block form, of a second grid moving mechanism, which is controlled by a second grid movement controller;

FIG. 12 is a perspective view, partly in block form, of a third grid moving mechanism, which is controlled by a third grid movement controller;

FIG. 13 is a diagram showing details of a data table; and

FIG. 14 is a diagram showing respective displacements per unit time stored in the data table.

### DESCRIPTION OF THE PREFERRED EMBODIMENTS

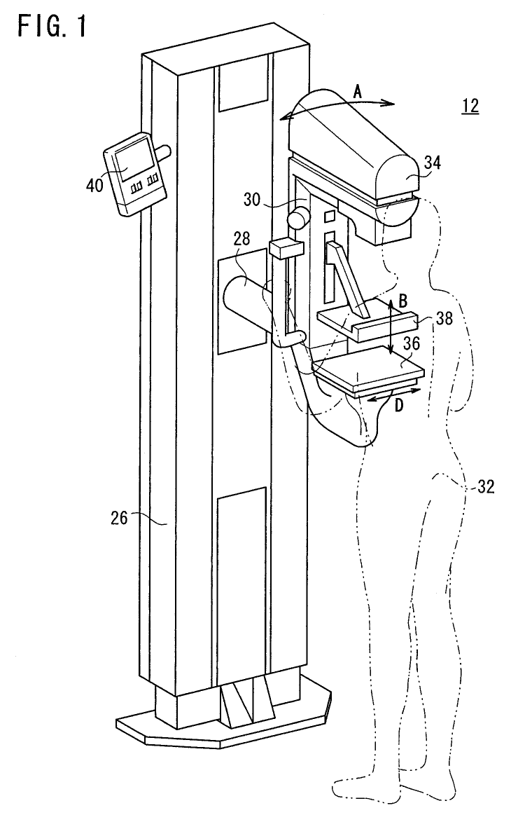

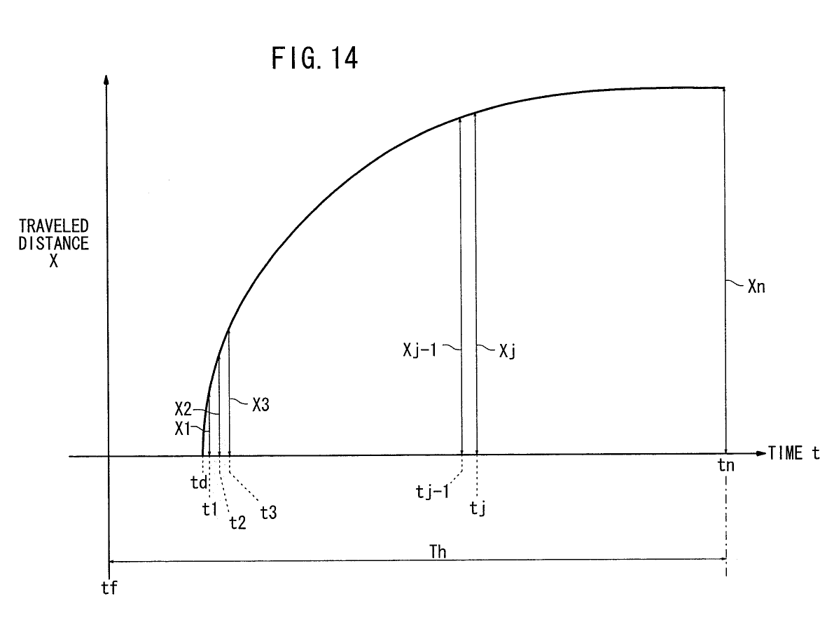

A radiation image capturing apparatus and a grid moving device according to an embodiment of the present invention, which are incorporated in a mammographic system, shall be described below with reference to FIGS. 1 through 14.

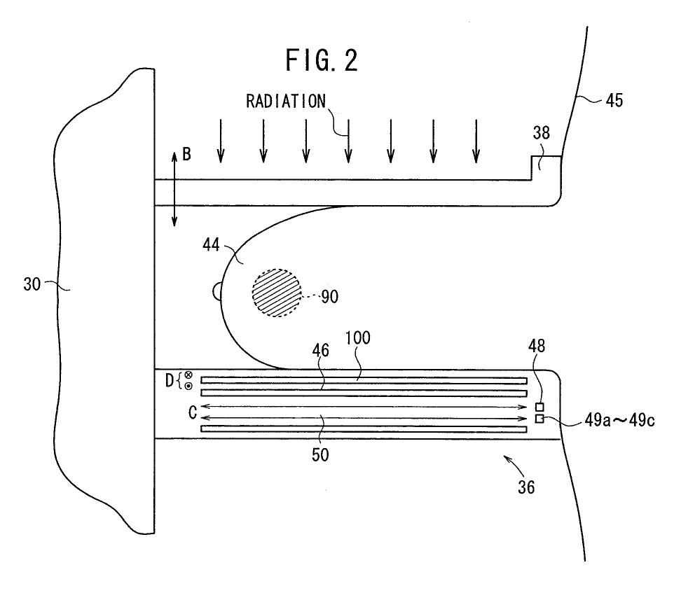

As shown in FIG. 1, a radiation image capturing apparatus 12 includes an upstanding base 26, a vertical arm 30 fixed to a horizontal swing shaft 28 disposed substantially centrally on the base 26, a radiation source housing unit 34 fixed to an upper end of the arm 30 and housing a radiation source for applying radiation to a breast 44 (see FIG. 2) to be imaged of a subject 32, an image capturing base 36 fixed to a lower end of the arm 30 and housing a solid-state detector 46 (radiation image information detector, see FIG. 2) for detecting radiation that has passed through the breast 44 in order to acquire radiation image information of the breast 44, and a breast compression plate 38 for pressing and holding the breast 44 against the image capturing base 36.

When the arm 30, to which the radiation source housing unit 34 and the image capturing base 36 are secured, is angularly moved about the swing shaft 28 in the directions indicated by the arrow A, an image capturing direction with respect to the breast 44 of the subject 32 is adjusted. The breast compression plate 38 is connected to the arm 16 and is disposed between the radiation source housing unit 34 and the image capturing base 36. The breast compression plate 38 is vertically displaceable along the arm 30 in the directions indicated by the arrow B.

A display control panel 40 is connected to the image capturing base 36 for displaying image capturing information including a region to be imaged of the subject 32 and an image capturing direction, as well as ID information of the subject 32, etc., detected by the radiation image capturing apparatus 12. The display control panel 40 also enables setting of such information, if necessary.

FIG. 2 shows internal structural details of the image capturing base 36 of the radiation image capturing apparatus 12. In FIG. 2, the breast 44 of the subject 32 is shown as being placed between the image capturing base 36 and the breast compression plate 38. Reference numeral 45 represents the chest wall of the subject 32.

The image capturing base 36 houses therein a solid-state detector 46 for storing radiation image information based on radiation that has been emitted from the radiation source stored in the radiation source housing unit 34 and that has passed through the breast 44, and outputting the stored radiation image information as electrical signals, a grid 100 disposed between the breast 44 and the solid-state detector 46 for removing scattered radiation rays caused by the breast 44, etc., a reading light source 48 for applying reading light to the solid-state detector 46, a plurality of automatic exposure control detectors (radiation dose information detectors, hereinafter referred to as “AEC sensors”) 49a through 49c for detecting the radiation dose of radiation that has passed through the breast 44 and the solid-state detector 46 in order to determine exposure control conditions for the radiation, and an erasing light source 50 for applying erasing light to the solid-state detector 46 in order to remove unwanted electric charges accumulated within the solid-state detector 46.

The solid-state detector 46 comprises a direct-conversion, light-reading radiation solid-state detector, for example. The solid-state detector 46 stores radiation image information as an electrostatic latent image, based on the radiation that has passed through the breast 44, and generates an electric current depending on the electrostatic latent image when the solid-state detector 46 is scanned by the reading light applied from the reading light source 48.

The solid-state detector 46 may be a detector as disclosed in Japanese Laid-Open Patent Publication No. 2004-154409, for example. More specifically, the solid-state detector 46 comprises a laminated assembly made up of a first electrically conductive layer disposed on a glass substrate through which the radiation passes, a recording photoconductive layer for generating electric charges upon exposure to radiation, a charge transport layer which acts substantially as an electric insulator with respect to latent image polarity electric charges developed within the first electrically conductive layer, and which acts substantially as an electric conductor with respect to transport polarity charges, which are of a polarity opposite to that of the latent image polarity electric charges, a reading photoconductive layer for generating electric charges and making itself electrically conductive upon exposure to the reading light, and a second electrically conductive layer, which is permeable by the radiation. An electric energy storage region is provided within a interface between the recording photoconductive layer and the charge transport layer.

Each of the first electrically conductive layer and the second electrically conductive layer provides an electrode. The electrode provided by the first electrically conductive layer comprises a two-dimensional flat electrode. The electrode provided by the second electrically conductive layer comprises a plurality of linear electrodes, which are spaced at a predetermined pixel pitch, for detecting radiation image information that is intended to be recorded as an image signal. The linear electrodes are arranged in an array along a main scanning direction, and extend in an auxiliary scanning direction perpendicular to the main scanning direction.

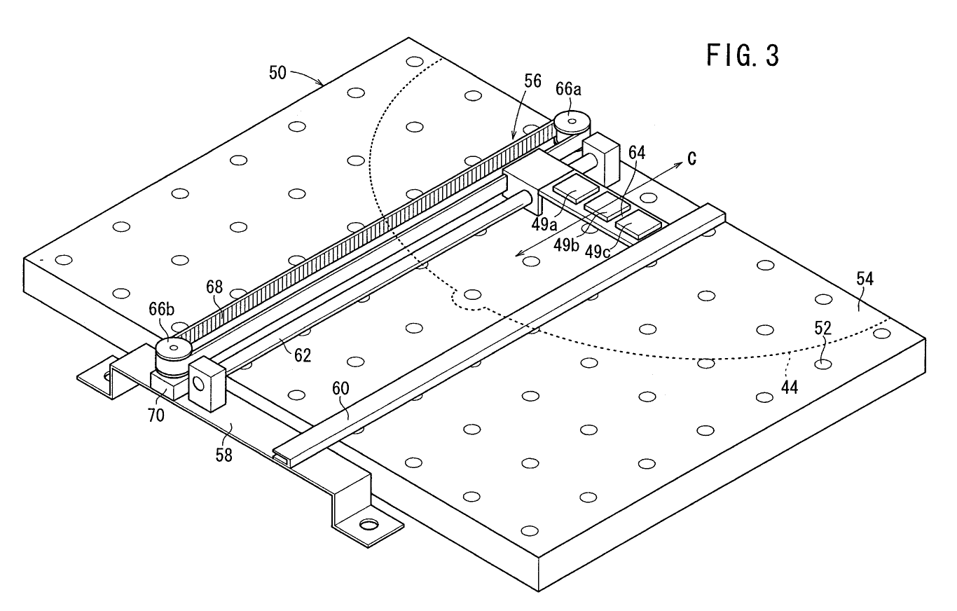

The reading light source 48 includes, for example, a line light source comprising a linear array of LED chips, which extend in a direction perpendicular to the depthwise direction of the image capturing base 36, as indicated by the arrow C (FIG. 3), and an optical system for applying a line of reading light emitted from the line light source to the solid-state detector 46. The line light source moves along the depthwise direction of the image capturing base 36 so as to expose and scan the entire surface of the solid-state detector 46.

As shown in FIG. 3, the erasing light source 50 comprises a plurality of LED chips 52, which can emit and quench light in a short period of time, and which have very short persistence, the LED chips being arranged on a panel 54. The panel 54 extends parallel to the solid-state detector 46 and is housed in the image capturing base 36.

As shown in FIG. 3, the AEC sensors 49a through 49c are movable in the directions indicated by the arrow C along the panel 54 of the erasing light source 50. The AEC sensors 49a through 49c are moved by a sensor moving mechanism 56. The sensor moving mechanism 56 comprises a guide rail 60 extending in directions indicated by the arrow C and having one end fixed to the panel 54 and another end thereof fixed to a bracket 58, a guide shaft 62 disposed parallel to the guide rail 60, a sensor board 64 supporting the AEC sensors 49a through 49c fixedly thereon and having opposite ends thereof slidably engaged with the guide rail 60 and the guide shaft 62, respectively, so that the sensor board 64 is movable in the directions indicated by the arrow C, an endless belt 68 trained around pulleys 66a, 66b rotatably supported on the panel 54 and the bracket 58, respectively, and fixed to one end of the sensor board 64, and a first motor 70 connected to the pulley 66b and energizable in order to displace the endless belt 68 between the pulleys 66a, 66b for moving the AEC sensors 49a through 49c fixedly mounted on the sensor board 64 in the directions indicated by the arrow C.

The AEC sensors 49a through 49c fixedly mounted on the sensor board 64 are disposed over a central area of the panel 54 and are symmetrically spaced predetermined distances from each other in a direction perpendicular to the direction indicated by the arrow C in which the sensor board 64 is movable.

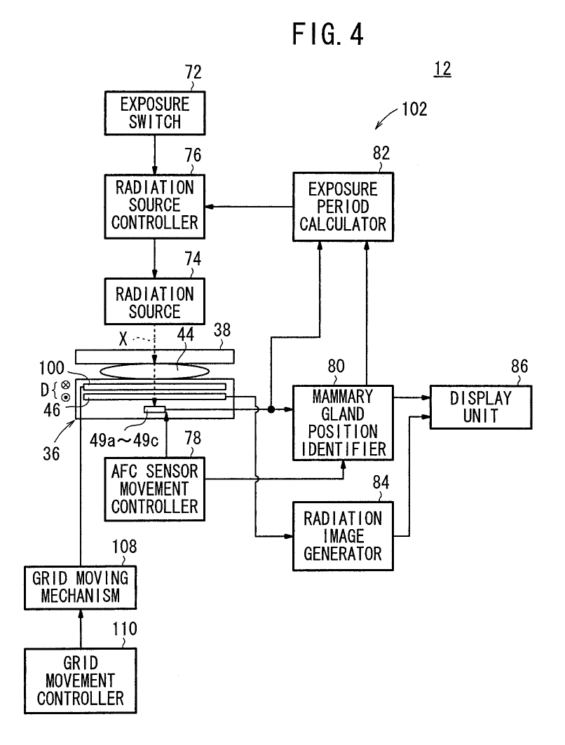

FIG. 4 shows in block form a control circuit 102 of the radiation image capturing apparatus 12.

As shown in FIG. 4, the control circuit 102 includes a radiation source controller 76 housed in the radiation source housing unit 34 for controlling a radiation source 74, which emits radiation when an exposure switch 72 is operated, an AEC sensor movement controller 78 for controlling the first motor 70 in order to control movement of the AEC sensors 49a through 49c, a mammary gland position identifier 80 for identifying the position of the mammary gland 90 (see FIG. 2) of the breast 44 based on the radiation dose detected by the AEC sensors 49a through 49c, and an exposure period calculator 82 for calculating an appropriate exposure period (hereinafter referred to as an “effective exposure period”) Ta for the radiation from the radiation source 74, based on a radiation dose per unit time (hereinafter referred to as a “unit radiation dose”) for the mammary gland position detected by the AEC sensors 49a through 49c, and for supplying the calculated exposure period as an exposure control condition to the radiation source controller 76.

The control circuit 102 also has a radiation image generator 84 for generating a radiation image based on the radiation image information detected by the solid-state detector 46, and a display unit 86 for displaying the generated radiation image. The display unit 86 also displays positional information, representing the mammary gland position identified by the mammary gland position identifier 80, e.g., an image representing the AEC sensors 49a through 49c, in overlapping relation to the radiation image.

The radiation image capturing apparatus 12 also includes a grid moving mechanism 108 for moving the grid 100 in directions indicated by the arrow D (i.e., directions perpendicular to the depthwise direction of the image capturing base 36, also referred to as lateral directions) between the breast 44 and the solid-state detector 46. The control circuit 102 includes a grid movement controller 110 for controlling the grid moving mechanism 108.

The grid moving mechanism 108 moves the grid 100 such that

vt=constant

where v represents the speed at which the grid 100 is moved, and t represents the period that has elapsed from the time that the grid 100 started to move.

Movement of the grid 100 controlled by the grid moving mechanism 108 for reducing grid irregularities shall be described below. For the sake of brevity, it shall be assumed that the time when the grid 100 starts to move, i.e., the movement start time td, and the time when the breast 44 starts to be exposed to radiation, i.e., the exposure start time te, are the same as each other.

As described above, the grid 100 serves to remove scattered radiation rays, which are produced when radiation passes through the subject 32. If radiation is applied to the subject 32 while the grid 100 is at rest, the radiation image information accumulated in the solid-state detector 46 contains therein grid stripes, which correspond to the grid 100. Such grid stripes are known as grid irregularities.

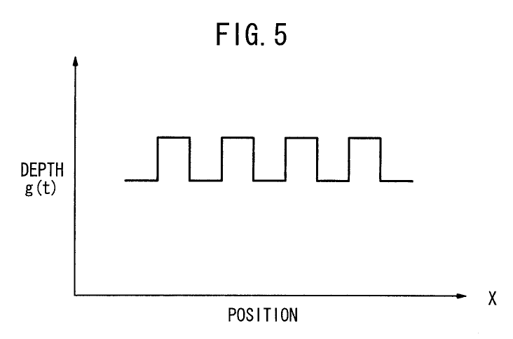

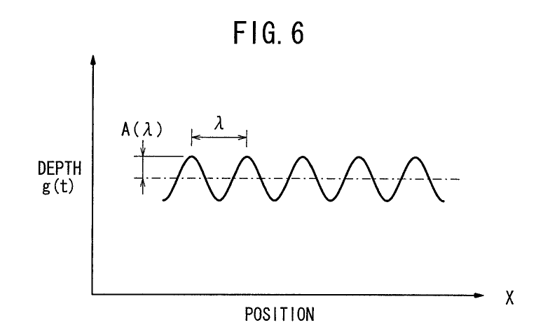

As shown in FIG. 5, a grid irregularity per unit time originally appears as an image having a waveform representing a train of rectangular pulses, in a graph having a horizontal axis representing positions in the horizontal direction (x) and a vertical axis representing the image information depth (e.g., pixel depth: the number of bits or the like). However, as shown in FIG. 6, the grid irregularity actually appears as an image having a waveform representing a train of sine curves, due to a MTF (Modulation Transfer Function), in accordance with the transmittance and the spatial frequency of the grid 100.

If a distance between adjacent peaks (or valleys) of the waveform, i.e., the grid wavelength of the grid 100, is represented by λ, the amplitude of the waveform is represented by A(λ), the speed at which the grid 100 is moved is represented by v, and the period that has elapsed from the movement start time td of the grid 100 is represented by t, then the waveform within the elapsed time period t is expressed by the following equation (2):

$$g ( t ) = A ( λ ) sin \{ \frac{2 π}{λ} ( x + vt ) \} \qquad ( 2 )$$

### In equation (2), x+vt may be indicated by x(t)=x+vt since it represents the movement of the grid 100.

The waveform according to equation (2) is integrated over the elapsed time t and added in the solid-state detector 46, wherein the waveform in the x direction, which is projected and accumulated in the solid-state detector 46 upon the elapse of the period t, is expressed by the following equation (3):

$$I ( t , x ) = {\int }_{0}^{t} g ( t ) = {\int }_{0}^{t} A ( λ ) sin \{ \frac{2 π}{λ} x ( t ) \} d t \qquad ( 3 )$$

A value produced by normalizing, with the elapsed period t, the difference between the maximum value I(t,x)max and the minimum value I(t,x)min in the x direction of the waveform I(t,x) according to equation (3) represents a grid irregularity Ga(t), as expressed by the following equation (4):

$$Ga ( t ) = \frac{I ( t , x ) max - I ( t , x ) min}{t} \qquad ( 4 )$$

If the grid 100 is held at rest, then the waveform in the x direction, which is projected and accumulated within the solid-state detector 46 upon elapse of the period t, is expressed by the following equation (5):

$$I ( t , x ) = {\int }_{0}^{t} A ( λ ) sin \{ \frac{2 π}{λ} x \} d t = A ( λ ) sin \{ \frac{2 π}{λ} x \} \qquad ( 5 )$$

Therefore, the grid irregularity Ga(t) when the grid 100 is held at rest is expressed by the following equation (6):

$$Ga ( t ) = \frac{A ( t ) t - ( - A ( λ ) t )}{t} = 2 A ( λ ) \qquad ( 6 )$$

The wave height A(λ) is thus uniquely calculated. As a result, once the movement x(t) of the grid 100 is determined, the grid irregularity Ga(t) during the elapsed period t can be calculated.

If equation (4) is expanded into a constant-velocity model, then the grid irregularity Ga(t) is expressed by the following equation (7):

$$Ga ( t ) = A ( λ ) {\frac{λ}{2 π vt} [ cos \{ \frac{2 π}{λ} ( x + vt ) \} - cos \{ \frac{2 π}{λ} x \} ]}_{max - min} \qquad ( 7 )$$

From equation (7), vt can be maximized in order to reduce the grid irregularity Ga(t). Since a constant-velocity model is assumed, it is necessary for vt to be constant in order to maximize the minimum value of vt, from a period t1 to a period t2 (t2>t1).

Accordingly, grid irregularity can be minimized by moving the grid 100 so that

vt=constant

where v represents the speed at which the grid 100 is moved, and t represents the period that has elapsed from the movement start time td.

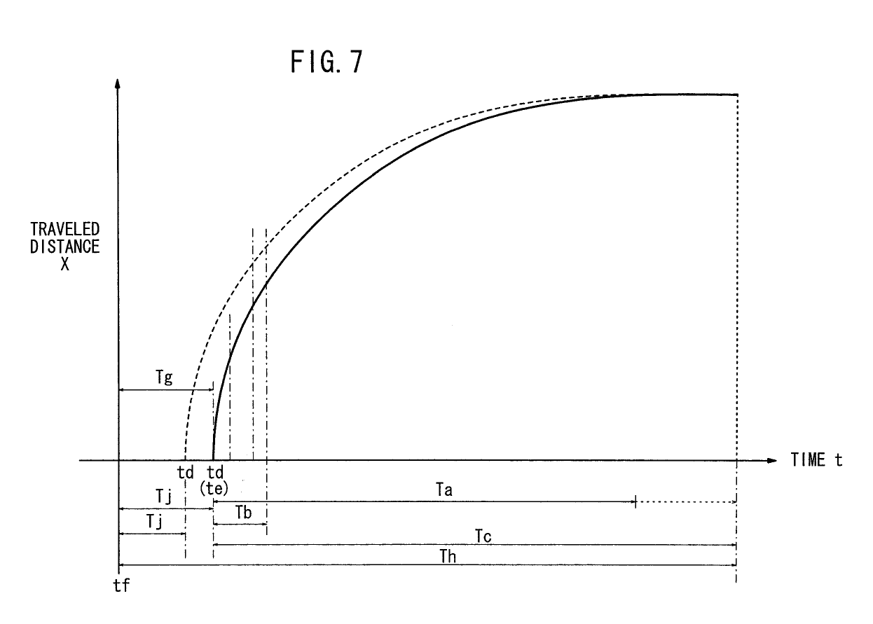

In order to satisfy the equation vt=constant, the grid 100 should be moved according to equation (1), shown below, for the distance X to be traveled by the grid 100 (see FIG. 7). If the period, which is the sum of a period (exposure start period Tg) from a reference time tf (e.g., a time at which the exposure switch 72 is operated) to the exposure start time te, and a maximum exposure period Tc is an exposure processing period Th in equation (1), then, although not indicated in equation (1), the base of the log is represented by the exposure processing period Th:

X=alog(t+b) (1)

where a and b represent coefficients inherent to the radiation image capturing apparatus 12. A process for determining the coefficients a and b shall be described below.

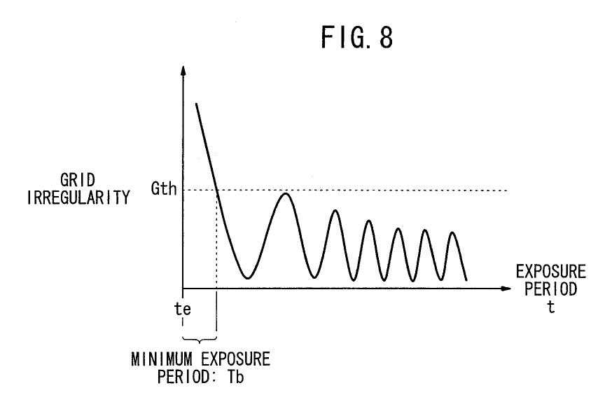

First, the coefficient b is determined base on a minimum exposure period Tb. The minimum exposure period Tb represents a period during which a minimum required radiation dose is supplied to the solid-state detector 46. As shown in FIG. 8, the minimum exposure period Tb can be determined from a change in the level of grid irregularity with respect to the exposure period t. An allowable level of grid irregularity is preset as a threshold value Gth, wherein the period consumed until the level of grid irregularity is reduced to the threshold level Gth, as the exposure period t elapses from the exposure start time te, serves as the minimum exposure period Tb. Specifically, a radiation dose emitted from the radiation source 74 is calculated (tube current: mA×energization period: s), based on the transmittance of a breast having a smallest thickness guaranteed by design specifications of the radiation image capturing apparatus 12, along with a minimum radiation dose required for performance of the solid-state detector 46. Then, the energization period is calculated with the tube current being set at a fixed value (i.e., with a constant unit radiation dose). The calculated energization period serves as a minimum exposure period Tb, and provides a basis for determining the coefficient b. Based on the coefficient b, a period (movement start period Tj) is established from the reference time tf (e.g., the time at which the exposure switch 72 is operated) to the movement start time td at which the grid 100 begins moving.

Next, the coefficient a is determined based on a maximum exposure period Tc and the stroke (maximum displacement) of the grid 100. The maximum exposure period Tc represents a period during which a maximum required radiation dose is supplied to the solid-state detector 46. Specifically, a radiation dose emitted from the radiation source 74 is calculated (tube current: mA×energization period: s), based on the transmittance of a breast having a largest thickness guaranteed by design specifications of the radiation image capturing apparatus 12, along with a maximum radiation dose required for performance of the solid-state detector 46. Then, the energization period is calculated with the tube current being set at a fixed value (i.e., with a constant unit radiation dose). The calculated energization period serves as a maximum exposure period Tc. The coefficient a is determined from the maximum exposure period Tc, the stroke (maximum displacement) of the grid 100, and the coefficient b determined as described above. The coefficients a and b are determined at the time the radiation image capturing apparatus 12 is shipped from the factory, and in principle, are not changed subsequently thereafter.

In the above example, it is assumed that the movement start time td of the grid 100 and the exposure start time te are the same as each other. However, if the minimum exposure period Tb is shorter than a predetermined period (e.g., a period preset at the time the radiation image capturing apparatus 12 is manufactured), in this case, the movement start time td of the grid 100 may be set to a time earlier than the exposure start time te. The effective exposure period Ta ends at a time after the minimum exposure period Tb has elapsed, and before the maximum exposure period Tc elapses or when the maximum exposure period Tc elapses.

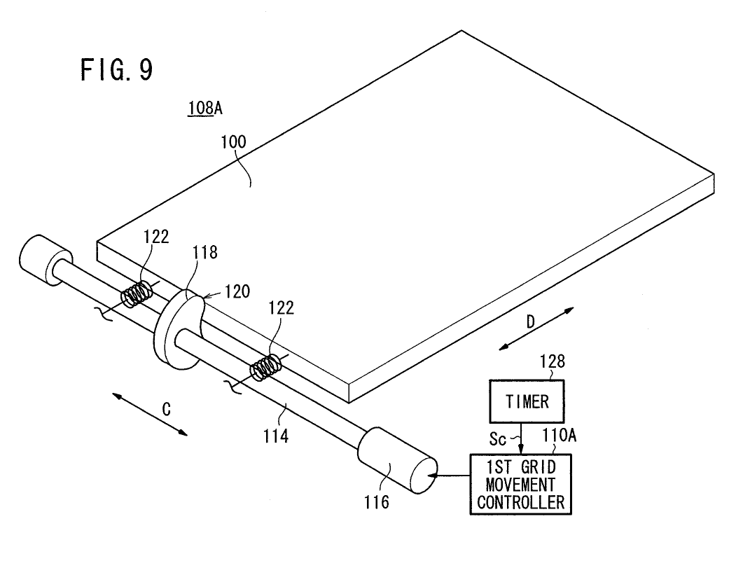

Specific structural details of the grid moving mechanism 108 and the grid movement controller 110 according to different specific examples shall be described below with reference to FIGS. 9 through 14.

As shown in FIG. 9, a grid moving mechanism according to a first specific example (hereinafter referred to as a “first grid moving mechanism 108A”) comprises a rotational shaft 114 having an axis extending along the depthwise direction of the image capturing base 36, as indicated by the arrow C, a second motor 116 for rotating the rotational shaft 114 about its own axis, a cam 120 mounted on the rotational shaft 114 and having a grid pressing surface 118 whose distance from the rotational shaft 114 varies continuously, a pair of tension springs 122 for normally urging the grid 100 to move toward the rotational shaft 114, and a guide rail (not shown) for guiding the grid 100 to move in directions indicated by the arrow D, i.e., lateral directions perpendicular to the directions indicated by the arrow C.

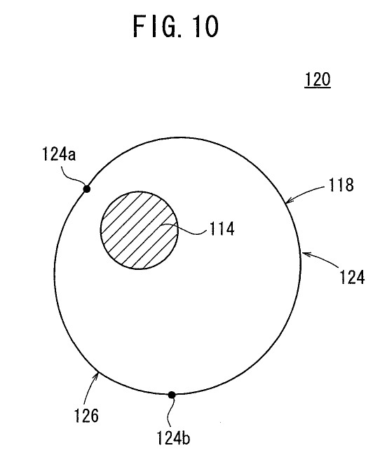

As shown in FIG. 10, the grid pressing surface 118 of the cam 120 includes a curved surface (first curved surface) 124 for moving the grid 100 over the traveled distance X, which is plotted according to the characteristic curve (log curve) shown in FIG. 7 while the rotational shaft 114 makes one revolution, i.e., while the rotational shaft 110 revolves 360° or through an angular interval smaller than 360°. The grid is in an initial position when the grid 100 is pressed by a starting end 124a of the first curved surface 124. When the grid 100 is pressed by a terminal end 124b of the first curved surface 124, the grid 110 is in a position corresponding to a time at which the exposure processing period Th has elapsed, i.e., a time at which the maximum exposure period Tc has elapsed from the exposure start time te, or in other words, the grid 110 is in a position where it has moved the maximum displacement.

The grid pressing surface 118 includes another curved surface (second curved surface) 126, which has a curved profile that allows the grid 100 to return to the initial position corresponding to the movement start time td, under the bias of tension springs 122 after the grid has been moved the maximum displacement distance by the first curved surface 124 of the grid pressing surface 118 upon rotation of the cam 120. The cam profile of the cam 120 shown in FIG. 10 is shown in an exaggerated form in order to facilitate understanding of the first grid moving mechanism.

A grid movement controller according to the first specific example (hereinafter referred to as a “first grid movement controller 110A”) measures the movement start period Tj that has been set based on a clock signal Sc from a timer 128 from the time tf when the exposure switch 72 is operated, and controls the second motor 116 upon elapse of the movement start period Tj. At the movement start time td, the starting end 124a of the first curved surface 124 of the cam 120 and the grid 100 confront each other. As the rotational shaft 114 rotates, the first curved surface 124 continuously presses the grid 100, so as to move the grid 100 along the characteristic curve shown in FIG. 7. Upon elapse of the exposure processing period Th from the reference time tf, i.e., at a time when the maximum exposure time Tc has elapsed from the exposure start time te, the terminal end 124b of the first curved surface 124 presses the grid 100. At this time, the grid 100 has traveled the maximum displacement from the initial position. Thereafter, the first grid movement controller 110A keeps rotating the rotational shaft 114 in order to cause the second curved surface 126 to press the grid 100, which returns gradually toward the initial position under the bias of the tension springs 122. When the starting end 124a of the first curved surface 124 of the cam 120 and the grid 100 confront each other again, the first grid movement controller 110A stops controlling movement of the grid 100.

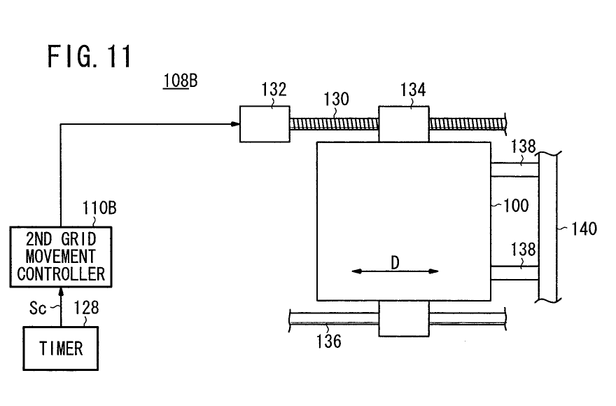

As shown in FIG. 11, a grid moving mechanism according to a second specific example (hereinafter referred to as a “second grid moving mechanism 108B”) comprises a feed screw 130 having an axis extending along the directions indicated by the arrow D, a third motor 132 for rotating the feed screw 130 about its own axis, a screw block 134 for converting rotary motion of the feed screw 130 into linear motion of the grid 100, a guide rail 136 for guiding the grid 100 to move in the directions indicated by the arrow D, and a pair of limiting means 138 for limiting movement of the grid 100.

The grid 100 is disposed between the screw block 134 and the guide rail 136. When the feed screw 130 is rotated about its own axis by the third motor 132, the screw block 134 slides along the feed screw 130 in the directions indicated by the arrow D, thereby moving the grid 100 in the directions indicated by the arrow D.

The limiting means 138 may comprise springs or dampers. Specifically, compression springs or dampers may be provided as the limiting means 138, between an end of the grid 100 and a side plate 140 mounted on the image capturing base 36, in the directions indicated by the arrow D.

A grid movement controller according to the second specific example (hereinafter referred to as a “second grid movement controller 110B”) measures the movement start period Tj based on a clock signal Sc from the timer 128 from the time tf when the exposure switch 72 is operated, and then controls the third motor 132 upon elapse of the movement start period Tj. The second grid movement controller 110B controls the third motor 132 in order to move the grid 100 at a constant velocity in the directions indicated by the arrow D, in the absence of the limiting means 138.

Actually, because the limiting means 138 is present, as the displacement of the grid 100 increases, the pressing force (limiting force) on the grid 100 also increases. As a result, the grid 100 moves such that the traveled distance X thereof is plotted according to the characteristic curve (log curve) shown in FIG. 7. Upon elapse of the exposure processing period Th from the reference time tf, the second grid movement controller 110B reverses the third motor 132 in order to rotate the feed screw 130 in an opposite direction about its own axis. Therefore, the grid 100 begins moving toward the initial position. When the grid 100 reaches the initial position, the second grid movement controller 110B stops controlling movement of the grid 100.

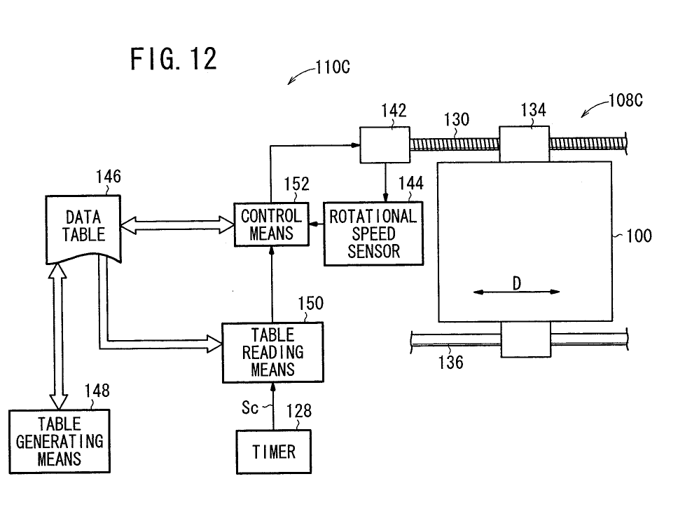

As shown in FIG. 12, a grid moving mechanism according to a third specific example (hereinafter referred to as a “third grid moving mechanism 108C”) comprises a feed screw 130, having an axis extending along the directions indicated by the arrow D, a fourth motor 142 for rotating the feed screw 130 about its own axis, a screw block 134 for converting rotary motion of the feed screw 130 into straight motion, a guide rail 136 for guiding the grid 100 so as to move in directions indicated by the arrow D, and a rotational speed sensor 144 for detecting the rotational speed of the feed screw 130 (the fourth motor 142). The fourth motor 142 may comprise a stepping motor, for example.

The grid 100 is disposed between the screw block 134 and the guide rail 136. When the feed screw 130 is rotated about its own axis by the fourth motor 142, the screw block 134 slides along the feed screw 130 in the directions indicated by the arrow D, thereby moving the grid 100 in the directions indicated by the arrow D.

On the other hand, a grid movement controller according to the third specific example (hereinafter referred to as a “third grid movement controller 110C”) comprises a table generating means 148 for generating a data table 146 of respective displacements of the grid 100 per unit time, based on the coefficients a, b and equation (1), a table reading means 150 for successively reading displacements from the data table 146 for the respective unit times, and a control means 152 for controlling the fourth motor 142 through a feedback loop, based on the detected signal from the rotational speed sensor 144, in order to move the grid 100 by the displacements read from the data table 146.

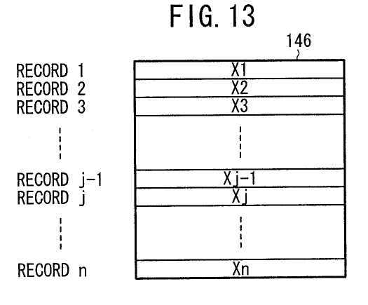

The data table 146 generated by the table generating means 148 stores therein respective displacements of the grid 100 per unit time, for the respective unit times that elapse from the movement start time td. Specifically, as shown in FIGS. 12 and 13, the data table 146 stores, as a record 1, a displacement X1 of the grid 100 at a time t1 when a unit time has elapsed from the movement start time td, stores, as a record 2, a displacement X2 of the grid 100 at a time t2 when a unit time has elapsed from the time t1, stores, as a record j, a displacement Xj of the grid 100 at a time tn when a unit time has elapsed from the time j-1, and stores, as a final record n, a displacement Xn, i.e., a maximum displacement, of the grid 100 at a time when the exposure processing period Th has elapsed from the reference time tf.

The table reading means 150 of the third grid movement controller 110C measures the movement start period Tj, based on a clock signal Sc from a timer 128 from the time tf when the exposure switch 72 is operated, and then controls the fourth motor 142 upon elapse of the movement start period Tj. Each time that a unit time elapses from the movement start time td, the table reading means 150 reads the displacement from a corresponding record in the data table 146, and the control means 152 controls the fourth motor 142 through a feedback loop in order to move the grid 100 by the read displacement. The grid 100, thus controlled in this manner, travels according to the characteristic curve shown in FIG. 7.

The radiation image capturing apparatus 12 according to the embodiment of the present invention is basically constructed as described above. Operations of the radiation image capturing apparatus 12 shall be described below.

Using a console, and an ID card, etc., (not shown), the operator or radiological technician sets the ID information of the subject 32, an image capturing process, etc. The ID information includes information as to the name, age, sex, etc., of the subject 32, and can be acquired from an ID card possessed by the subject 32. If the radiation image capturing apparatus 12 is connected to a network, then the ID information can be acquired through the network from a higher-level apparatus. The image capturing process includes information with respect to the region to be imaged, an image capturing direction, etc., as instructed by the doctor, and can be acquired through the network from a higher-level apparatus, or can be entered from the console by the radiological technician. Such information can be displayed on the display control panel 40 of the radiation image capturing apparatus 12.

Thereafter, the radiological technician places the radiation image capturing apparatus 12 into a certain state according to the specified image capturing process. For example, the breast 44 may be imaged as a cranio-caudal view (CC) taken from above, a medio-lateral view (ML) taken outwardly from the center of the chest, or a medio-lateral oblique view (MLO) taken from an oblique view. Depending on information of a selected one of such image capturing directions, the radiological technician turns the arm 30 about the swing shaft 28. In FIG. 1, the radiation image capturing apparatus 12 is set to take a cranio-caudal view (CC) of the breast 44.

Then, a radiological technician positions the breast 44 of the subject 2 with respect to the radiation image capturing apparatus 12. For example, the radiological technician places the breast 44 on the image capturing base 36, and thereafter lowers the breast compression plate 38 toward the image capturing base 36, as shown in FIG. 2, so as to hold the breast 44 between the image capturing base 36 and the breast compression plate 38.

After completion of the above preparatory process, the radiation image capturing apparatus 12 starts to capture an image of the breast 44.

First, the radiation image capturing apparatus 12 operates in a pre-exposure mode, in which the radiation does applied to the breast 44 is set at a low level, in order to determine exposure control conditions for the mammary gland region, which is a region of interest. Thereafter, the radiation image capturing apparatus 12 operates in a main exposure mode, in which the breast 44 is irradiated with a radiation dose according to exposure control conditions determined during the pre-exposure mode. Specific details of the pre-exposure mode and the main exposure mode shall be described below.

First, the pre-exposure mode will be described below. The radiation source controller 76 controls a tube current supplied to the radiation source 22 so as to set the radiation dose per unit time at a low level, and applies the low-level radiation dose to the breast 44.

Before radiation starts being applied to the breast 44, the AEC sensors 49a through 49c are positioned at an end region of the image capturing base 36 near the chest wall 45 of the subject 32. Immediately before radiation begins being applied to the breast 44, or at the same time radiation is applied to the breast 44, the AEC sensors 49a through 49c start to move from the chest wall 45 toward the nipple of the breast 44. Specifically, the AEC sensor movement controller 78 energizes the first motor 70 in order to displace the endless belt 68, to thereby cause the sensor board 64 engaging the endless belt 68 to move the AEC sensors 49a through 49c from the chest wall 45 toward the nipple of the breast 44.

As the AEC sensors 49a through 49c are thus moved, they detect the radiation dose of radiation having passed through the breast compression plate 38, the breast 44, and the solid-state detector 46, wherein the detected radiation dose then is supplied to the mammary gland position identifier 80.

The mammary gland position identifier 80 calculates a radiation dose per unit time (unit radiation dose), from the radiation dose detected by the AEC sensors 49a through 49c at given sampling times, and identifies the mammary gland position based on the calculated unit radiation dose.

After the mammary gland position identifier 80 has identified the mammary gland position, the exposure period calculator 82 calculates as an exposure control condition an effective exposure period Ta for applying a radiation dose required to obtain appropriate radiation image information of the mammary gland region of the breast 44, based on the unit radiation dose detected by the AEC sensors 49a through 49c in the mammary gland position.

Since the solid-state detector 46 has accumulated radiation image information recorded during the pre-exposure mode, the solid-state detector 46 is irradiated with erasing light from the erasing light source 50, in order to erase such radiation image information prior to the main exposure mode. Then, operation of the radiation image capturing apparatus 12 in the main exposure mode is initiated.

The radiation source controller 76 sets the tube current, which is supplied to the radiation source 74, to a current for obtaining a radiation dose per unit time required for the main exposure mode. Then, the radiological technician operates the exposure switch 72 to start moving the grid 100 at a time when the movement start period Tj has elapsed from the reference time tf, i.e., at the movement start time td, and the radiation source 74 controlled by the current applies radiation to the breast 44 from the exposure start time te. The breast 44 is irradiated with radiation for an effective exposure period Ta. During the effective exposure period Ta, since the grid 100 is moved according to the characteristic curve shown in FIG. 7 in one of the directions D indicated by the arrow D, generation of grid irregularities in the solid-state detector 46 is held to a minimum. When the effective exposure period Ta elapses, application of radiation to the breast 44 is halted. When the maximum exposure period elapses, the grid 100 reaches a position corresponding to a maximum displacement thereof, at a substantially nil speed.

Radiation that has passed through the breast 44, which is held between the breast compression plate 38 and the image capturing base 36, is applied to the solid-state detector 46 housed in the image capturing base 36, whereby radiation image information of the breast 44 is recorded. After radiation image information of the breast 44 has been captured, the reading light source 48 moves in one of the directions indicated by the arrow C along the solid-state detector 46 in order to read radiation image information recorded within the solid-state detector 46. The radiation image information is supplied to the radiation image generator 84, which produces a radiation image based on the supplied radiation image information. The generated radiation image and an image of the mammary gland region are displayed on the display unit 86. Then, in order to prepare the solid-state detector 46 for capturing a subsequent radiation image, the solid-state detector 46, from which radiation image information has been read, is irradiated with erasing light emitted from the erasing light source 50 in order to remove unwanted electric charges stored within the solid-state detector 46.

With the radiation image capturing apparatus 12 according to the present embodiment, since the grid 100 for removing scattered radiation rays produced when radiation passes through the subject 32 is moved so that

vt =constant

where v represents the speed at which the grid 100 is moved, and t represents the period that has elapsed from the movement start time, generation of grid irregularities is held to a certain level or lower, regardless of the length of the effective exposure period Ta. Inasmuch as the grid 100 reaches a position corresponding to the maximum displacement at a substantially nil speed, the load applied to the grid 100 in order to return the grid 100 to its initial position, i.e., the load applied to the grid 100 when the grid moves from the position corresponding to its maximum displacement, is reduced. Therefore, the grid moving mechanism 108 is highly durable and produces low noise.

In the above embodiment, it is assumed that the unit radiation dose is constant as the time t elapses. However, if the unit radiation dose varies with time, then the grid 100 may be moved so that

E(t)/vt=constant

where v represents the speed at which the grid 100 is moved, t represents the period that has elapsed from the movement start time, and E(t) represents a time-dependent change in the unit radiation dose.

Although a certain preferred embodiment of the present invention has been shown and described in detail, it should be understood that various changes and modifications may be made to the embodiment without departing from the scope of the invention as set forth in the appended claims.

What is claimed is:

1. A radiation image capturing apparatus comprising:
a radiation source for applying radiation to a subject;
a radiation image information detector for detecting radiation from said radiation source that has passed through said subject in order to capture radiation image information of said subject;
a grid disposed between said subject and said radiation image information detector for removing scattered radiation rays produced when said radiation passes through said subject; and
a grid moving mechanism for moving said grid in at least one direction;
wherein said grid moving mechanism moves said grid so that
vt=constant
where v represents a speed at which said grid is moved, and t represents a period elapsed from a time when said grid starts to move.

2. A radiation image capturing apparatus according to claim 1, wherein said grid moving mechanism moves said grid a distance X to be traveled by said grid, according to the following equation (1):
X=alog(t+b) (1)
where a and b represent coefficients inherent to the radiation image capturing apparatus.

3. A radiation image capturing apparatus according to claim 2, wherein said grid moving mechanism determines the coefficient b of said equation (1) based on a minimum exposure period, during which a minimum radiation dose of required radiation is supplied to said radiation image information detector.

4. A radiation image capturing apparatus according to claim 2, wherein said grid moving mechanism determines the coefficient a of said equation (1) based on a maximum exposure period, during which a maximum radiation dose of required radiation is supplied to said radiation image information detector, together with a maximum displacement of said grid.

5. A radiation image capturing apparatus according to claim 2, wherein said grid moving mechanism determines the coefficient b of said equation (1) based on a minimum exposure period, during which a minimum radiation dose of required radiation is supplied to said radiation image information detector, and thereafter determines the coefficient a of said equation (1) based on a maximum exposure period, during which a maximum radiation dose of required radiation is supplied to said radiation image information detector, together with a maximum displacement of said grid.

6. A radiation image capturing apparatus according to claim 2, wherein said grid moving mechanism comprises:
a rotational shaft, which is rotatable in a period that is longer than a maximum exposure period, during which a maximum radiation dose of required radiation is supplied to said radiation image information detector; and
a cam mounted on said rotational shaft and including a grid pressing surface whose distance from said rotational shaft varies continuously,
wherein said grid moving mechanism moves said grid according to said equation (1) by rotating said rotational shaft.

7. A radiation image capturing apparatus according to claim 6, wherein said grid moving mechanism further comprises urging means for urging said grid to move toward said rotational shaft.

8. A radiation image capturing apparatus according to claim 2, wherein said grid moving mechanism comprises:
moving means for moving said grid in at least one direction; and
limiting means for limiting movement of said grid by said moving means,
wherein said grid moving mechanism moves said grid according to said equation (1) by moving said grid with said moving means together with limiting movement of said grid by said limiting means.

9. A radiation image capturing apparatus according to claim 8, wherein said limiting means comprises one of a spring and a damper.

10. A radiation image capturing apparatus according to claim 2, wherein said grid moving mechanism comprises:
a motor;
a rotation-to-linear-movement converting mechanism for converting rotary motion of said motor into linear motion of said grid; and
control means for controlling the rotary motion of said motor,
wherein said control means controls said motor to move said grid according to said equation (1).

11. A radiation image capturing apparatus comprising:
a radiation source for applying radiation to a subject;
a radiation image information detector for detecting radiation from said radiation source that has passed through said subject in order to capture radiation image information of said subject;
a grid disposed between said subject and said radiation image information detector for removing scattered radiation rays produced when radiation passes through said subject; and
a grid moving mechanism for moving said grid in at least one direction,
wherein said grid moving mechanism moves said grid so that
E(t)/vt=constant
where v represents a speed at which said grid is moved, t represents a period elapsed from a time when said grid starts to move, and E(t) represents a time-dependent change in the dose of the radiation.

12. A grid moving device in a radiation image capturing apparatus, said radiation image capturing apparatus comprising:
a radiation source for applying radiation to a subject; and
a radiation image information detector for detecting radiation from said radiation source that has passed through said subject in order to capture radiation image information of said subject,
wherein said grid moving device comprises:
a grid disposed between said subject and said radiation image information detector for removing scattered radiation rays produced when radiation passes through said subject; and
a grid moving mechanism for moving said grid in at least one direction,
wherein said grid moving mechanism moves said grid so that
vt=constant
where v represents a speed at which said grid is moved, and t represents a period elapsed from a time when said grid starts to move.

13. A grid moving device in a radiation image capturing apparatus, said radiation image capturing apparatus comprising:
a radiation source for applying radiation to a subject; and
a radiation image information detector for detecting radiation from said radiation source that has passed through said subject in order to capture radiation image information of said subject,
wherein said grid moving device comprises:
a grid disposed between said subject and said radiation image information detector for removing scattered radiation rays produced when radiation passes through said subject; and
a grid moving mechanism for moving said grid in at least one direction,
wherein said grid moving mechanism moves said grid so that
E(t)/vt=constant
where v represents a speed at which said grid is moved, t represents a period elapsed from a time when said grid starts to move, and E(t) represents a time-dependent change in the radiation dose.
